(19) United States
(12) Patent Application Publication
(10) Pub. No.: US 2007/0099575 A1
(43) Pub. Date: May 3, 2007

(54) Transceiver and adjusting system for transceiver

(75) Inventor: Nobuyoshi Nagai, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/588,226

(22) Filed: Oct. 27, 2006

(30) Foreign Application Priority Data
Oct. 28, 2005 (JP) 2005-315212

(51) Int. Cl. H04B 17/00

(52) U.S. Cl. 455/67.11

(57) ABSTRACT

A transceiver adjusting system is formed with a transceiver and a measuring device. The transceiver includes a transmitter for transmitting a radio wave wirelessly, a receiver for receiving a radio wave wirelessly from the measuring device, and a rewritable memory for storing a set value to control the electrical characteristic of the transmitter and/or the receiver. The transceiver further includes a controller for controlling the electrical characteristics of the transmitter and/or the receiver based on the set value and rewriting the set value stored in the memory to the set value received by the receiver, when the radio waves containing the set value are received by the receiver.

### CROSS REFERENCE TO RELATED APPLICATION

This application is based on and incorporates herein by reference Japanese Patent Application No. 2005-315212 filed on Oct. 28, 2005.

### FIELD OF THE INVENTION

The present invention relates to a transceiver and an adjusting system for the transceiver.

### BACKGROUND OF THE INVENTION

A packaged transceiver is produced by accommodating a circuit board having circuit devices mounted thereon in a case or molding the circuit board with mold resin. When the electrical characteristic of such a transceiver is to be adjusted, a probe pin or the like is brought into contact with the circuit board and a set value is written into a memory of the circuit device or the like before packaging.

However, when the circuit board having the circuit devices mounted thereon is molded, capacitance components are formed between the circuit devices and between each circuit device and the circuit board by the mold resin. If the capacitance components are formed by the mold resin, the electrical characteristic of the transceiver may be varied. Furthermore, when the circuit board having the circuit devices mounted thereon is accommodated in a case, the electrical characteristic of the transceiver may be varied in accordance with the case.

As described above, the electrical characteristic may be varied before and after packaging, and thus a transceiver having a desired electrical characteristic cannot be achieved.

Furthermore, when the adjusting is executed by bringing the probe pin or the like into contact with the circuit board to write a set value into the circuit device or the like, mechanical control for bringing the probe pin into contact with the circuit board is required. In addition, it needs time to bring the probe pin into contact with a test point and to separate the probe pin from the test point. As a result, the adjusting time is increased and the manufacturing cost is increased.

### SUMMARY OF THE INVENTION

The present invention therefore has an object to provide a transceiver that can shorten an adjusting time and has a proper electrical characteristic, and an adjusting system for the transceiver that can adjust the electrical characteristic of the transceiver to a proper electrical characteristic.

According to one aspect of the present invention, a transceiver comprises a transmitter for transmitting a radio wave wirelessly, a receiver for receiving a radio wave wirelessly transmitted from a measuring device, and a rewritable memory for storing a set value to control an electrical characteristic of at least one of the transmitter and the receiver. The transceiver further comprises a controller for controlling the electrical characteristic of the at least one of the transmitter and the receiver based on the set value, and rewriting the set value stored in the memory to an adjusting set value received by the receiver when the radio wave containing the set value is received by the receiver.

According to another aspect of the present invention, a measuring device is provided in combination with the transceiver. The measuring device comprises a device-side transmitter for transmitting the radio wave wirelessly to the transceiver, a device-side receiver for receiving the radio wave wirelessly from the transceiver, and a device-side controller for setting the adjusting set value to control an electrical characteristic of the transceiver based on the radio wave transmitted from the transceiver and transmitting the radio wave containing the adjusting set value from the device-side transmitter.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic block diagram showing an adjusting system according to a first embodiment of the present invention;

FIG. 2 is a schematic view showing a portable device in the first embodiment of the present invention;

FIG. 3 is a flowchart showing the processing operation of a measuring device in the first embodiment of the present invention;

FIG. 4 is a flowchart showing the processing operation of the portable device in the first embodiment of the present invention;

FIG. 5 is a table showing an example of an adjusting map in the first embodiment of the present invention; and

FIG. 6 is a diagram showing an adjusting system according to a second embodiment of the present invention.

### DETAILED DESCRIPTION OF THE PREFERRED EMBODIMENTS

### First Embodiment

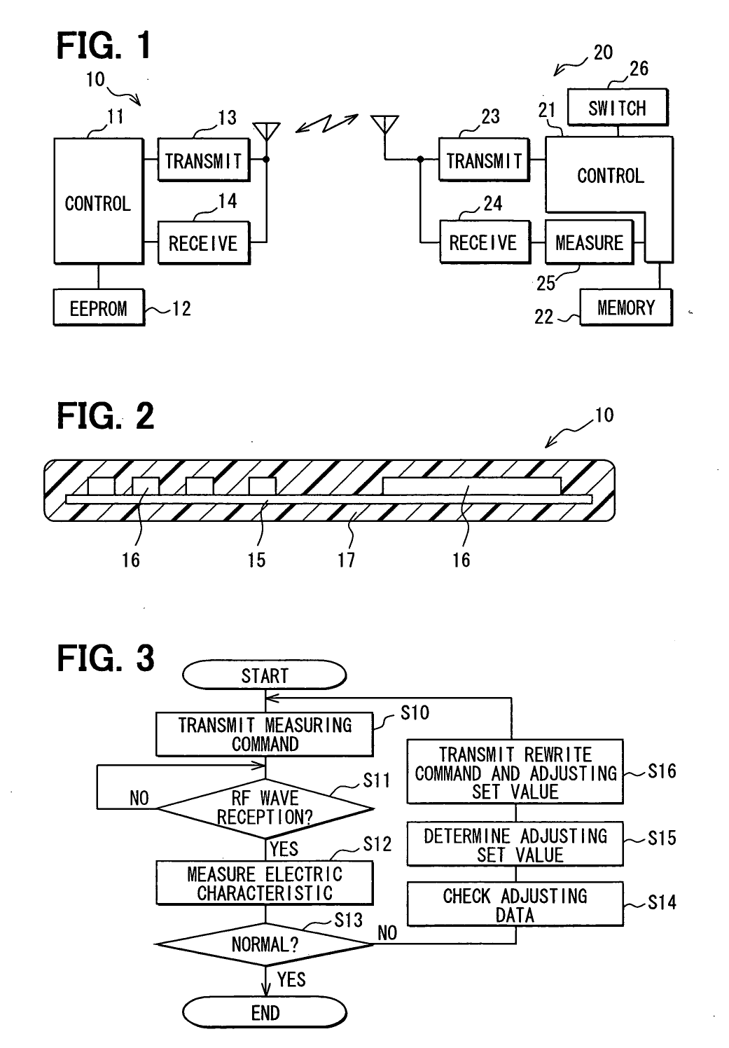

Referring to FIG. 1, an adjusting system includes a portable device (transceiver) 10 and a measuring device (tester) 20, which are wirelessly connected to each other. The portable device 10 is a transmitter/receiver, which may be used in a smart entry system for remotely locking/unlocking doors of a vehicle in a non-contact way, etc.

The portable device 10 is equipped with a transceiver-side controller 11, a transceiver-side EEPROM (electrically erasable programmable memory) 12, a transceiver-side transmitter 13, a transceiver-side receiver 14, etc. The controller 11 is a microcomputer having a CPU, etc., and controls the transmitter 13, the receiver 14, etc. based on a set value stored in the EEPROM 12.

The EEPROM 12 is a rewritable storage device. In EEPROM 12 are stored a set value for controlling the transmission power, the transmission frequency, etc. when a radio wave is transmitted from the transmitter 13.

When the adjusting system is used in the smart entry system, the controller 11 determines reception or non-reception of a request signal based on the reception signal of the receiver 14, generates a response signal containing ID code, etc. in response to the request signal, transmits the response signal from the transmitter 13, etc. In EEPROM 12 are also stored an ID code specific to the portable device 10, etc. when the portable device 10 is used in the smart entry system.

The transmitter 13 is equipped with an RF circuit for transmitting RF radio wave, etc., superposes a signal output from the controller 11 on a modulated RF radio wave, and then transmits the signal from the antenna wirelessly. When the radio wave is transmitted from the transmitter 13 wirelessly, the controller 11 controls the electrical characteristic (transmission power, transmission frequency) based on the set value stored in EEPROM 12.

The receiver 14 demodulates a radio wave which is transmitted from the external location wirelessly and received by the antenna, and then outputs the demodulated signal to the controller 11.

As shown in FIG. 2, the portable device 10 is equipped with a circuit board 15, circuit devices 16 and an antenna (not shown), and is molded with mold resin 17 while the circuit devices 16, the antenna, etc. are mounted on the board 15 in an electronic product state.

The measuring device 20 is equipped with a tester-side controller 21, a tester-side memory (memory) 22, a tester-side transmitter 23, a tester-side receiver 24, a tester-side measuring circuit 25, etc. The controller 21 is a microcomputer having a CPU, etc., and controls the transmitter 23, the receiver 24, the measuring circuit 25, etc.

The memory 22 may be a hard disk, ROM or the like, and an adjusting set value is stored in the memory 22. The adjusting set value is used to control the electrical characteristic of the transmitter 13 in the portable device 10. Those are stored in association with the measuring result (measurement values) of the measuring circuit 25 as shown in an adjusting data in mapped form of FIG. 5.

The transmitter 23 has an LF circuit, etc., and it superposes a signal output from the controller 21 on the modulated LF radio wave and transmits the signal from the antenna wirelessly. The signal output from the controller 21 contains a signal indicating the adjusting set value, a transmission request signal (measuring command) for requesting wireless transmission of a radio wave from the portable device 10 to start the measurement, etc.

The receiver 24 demodulates the radio wave which are wirelessly transmitted from the portable device 10 and received by the antenna, and then outputs the demodulated signal to the controller 21.

The measuring circuit 25 measures the electrical characteristic (transmission power, transmission frequency) of the transmitter 13 based on the radio wave which is transmitted wirelessly from the portable device 10.

The operating switch 26 is operable by an operator of the measuring device 20, and outputs an operation signal indicating that it is operated by the operator.

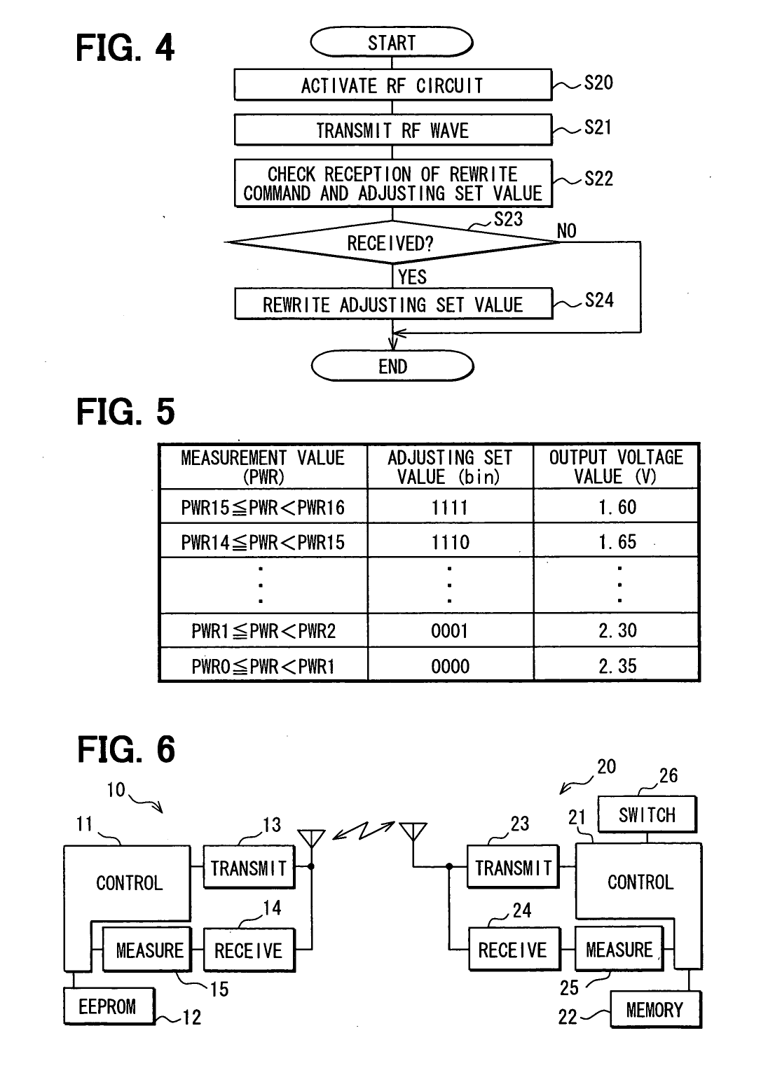

The adjusting system is further constructed or programmed to operate as shown in FIGS. 3 and 4. When the operation switch 26 of the measuring device 20 is operated, the operation signal indicating the start of the measurement is output. When a measurement command is received from the measuring device 20, the portable device 10 starts the processing shown in FIG. 4.

Specifically, at step S10, the controller 21 superposes the measuring command requesting the wireless transmission of radio waves from the portable device 10 on the modulated LF radio wave and then wirelessly transmits the signal from the antenna by the transmitter 23.

When the portable device 10 receives the measuring command transmitted from the measuring device 20 by the receiver 14, controller 11 activate the RF circuit of the transmitter 13 at step S20 to prepare for the wireless transmission of the RF radio wave. At step S21, the controller 11 controls the transmission power and the transmission frequency based on the set value stored in EEPROM 12 and wirelessly transmits the RF radio wave from the transmitter 13.

At step S11, in response to the measuring command transmitted at step S10, the measuring device 20 determines whether the RF radio wave is transmitted from the portable device 10, that is, the RF radio wave is received by the receiver 24. If it is determined that the RF radio wave is received, the processing proceeds to step S12. On the other hand, if it is determined that no RF radio wave is received, the determination at step S11 is repeated. At step S11, the processing is finished when no RF radio wave cannot be received although reception of the RF radio wave is confirmed at a predetermined number of times.

At step S12, the controller 21 measures the electric characteristic (e.g., transmission power and transmission frequency) of the transmitter 13 by using the RF radio wave received through the measuring circuit 25. At step S13, the controller 21 determines whether the measurement result at step S12 is normal or not, that is, whether it is within a standard range. This determination may be carried out by storing a predetermined reference value in the memory 22 or the like in advance and comparing the measurement result of the measuring circuit 25 with the stored reference value. If it is determined that the measurement result is within the standard range, the processing is finished. If it is determined that the measurement result is not within the standard range, the processing proceeds to step S14.

It is also possible to shift the processing to step S14 irrespective of the measurement result when the electrical characteristic is measured at step S12. In this case, by shifting the processing to step S14 to set the adjusting set value only when it is determined that the electrical characteristic of the transmitter 13 is not normal, the radio waves can be transmitted only as occasion demands.

At step S14, when the measurement result of the measuring circuit 25 is not normal, the controller 21 checks the adjusting data shown in FIG. 5 so that the transmission power and the transmission frequency of the transmitter 13 in the portable device 10 are set to normal values.

At step S15, the controller 21 determines the adjusting set value corresponding to the measurement result, that is, the measurement value of the measuring circuit 25 by using the adjusting data.

At step S16, the controller 21 superposes a rewriting command and the adjusting set value on the modulated LF radio wave and wirelessly transmits the signal from the antenna by the transmitter 23 in order to write the adjusting set value determined at step S15 into EEPROM 12.

At step S22, the controller 11 checks the reception of the rewriting command and the adjusting set value through the receiver 14. Then, at step S23, the controller 11 determines whether the rewriting command and the adjusting set value is received or not. If it is determined that they are received, the processing proceeds to step S24. If it is determined that they are not received, the processing is finished.

At step S24, the controller 11 rewrites the set value presently stored in EEPROM 12 with the received adjusting set value according to the received rewriting command. That is, the present adjusting values are replaced with new adjusting set value.

As described above, when the set value for controlling the electrical characteristic of the transmitter 13 into EEPROM 12, and the radio wave containing the adjusting set value is wirelessly received through the receiver 14, the set value stored in EEPROM 12 are rewritten to the adjusting set value received through the receiver 14, whereby the electrical characteristic can be adjusted even after the portable device 10 is packaged in a case or by mold resin. Accordingly, the portable device 10 can be provided with a proper electrical characteristic without paying attention to the variation amount caused by the mold resin, the case, etc.

Furthermore, the set value stored in EEPROM 12 can be rewritten in the stage that the portable device 10 is under product state. Therefore, no defective occurs in the manufacturing process of the portable device 10.

Still furthermore, with respect to the adjusting set value, the measuring device 20 measures the electrical characteristic of the transmitter 13 based on the radio wave transmitted from the portable device 10. The adjusting set value is set by using the measurement result to rewrite the set value stored in EEPROM 12, so that the electrical characteristic of the portable device 10 can be more properly adjusted.

It has been general that when a set value are written, a probe pin is brought into contact with a test pointer provided on the board under the state that circuit devices and an antenna are mounted (circuit state) in consideration of the influence of the mold resin or the case. However, according to this embodiment, the adjusting set value can be written into EEPROM 12 of the portable device 10 wirelessly. Thus it is unnecessary to provide a test pointer in the portable device 10, and restriction on the artwork can be reduced. Furthermore, the adjusting set value can be written into EEPROM 12 of the portable device 10 wirelessly, so that it is unnecessary to bring the probe pin into contact with the test pointer and thus the adjusting time can be shortened.

When a power source such as a cell or the like for driving the controller 11, etc. is mounted in the portable device 10, the electrical characteristic of the transmitter 13 may be varied by the power source. However, according to this embodiment, the adjusting set value can be written into EEPROM 12 of the portable device 10 wirelessly. Thus, the set value stored in EEPROM 12 can be rewritten in the stage where the portable device 10 is under product state. Accordingly, the portable device 10 can be provided with a proper electrical characteristic without paying attention to the variation amount caused by the power source.

### Second Embodiment

In this embodiment, the portable device 10 is equipped with a measuring circuit 15 for measuring the electrical characteristic (reception sensitivity, reception frequency) of the receiver 14 based on the radio wave wirelessly transmitted from the measuring device 20.

When the operation switch 26 is operated and the operation signal indicating the start of the measurement is output, the controller 21 superposes on the modulated LF radio wave the measuring command requesting wireless transmission of the radio wave from the portable device 10 to start the measurement, and wirelessly transmits the signal from the antenna by the transmitter 23.

When wirelessly receiving the LF radio wave containing the measuring command in the receiver 14, the controller 11 measures the electrical characteristic (reception sensitivity, the reception frequency) of the receiver 14 by using the received LF radio wave in the measuring circuit 15.

Then, the controller 11 controls the transmission power and the transmission frequency based on the set value stored in EEPROM 12. It superposes the signal indicating the measurement result measured in the measuring circuit 15 on the modulated RF radio wave and wirelessly transmits the signal thus achieved from the transmitter 13.

The measuring device 20 which wirelessly receives the RF radio wave containing the measurement result measured in the measuring circuit 15 executes a determination as to whether the measurement result is normal or not, check of the adjusting map, determination of the adjusting set value, transmission of the rewriting command and the adjusting set value, etc. in the similar manner as steps S13 to S16 of the first embodiment.

When the rewriting command and the adjusting set value is received by the receiver 14, the controller 11 rewrites the present a set value stored in EEPROM 12 with the received adjusting set value according to the received rewriting command.

As described above, the radio wave containing the measurement result measured based on LF radio wave received by the receiver 14 is transmitted to the measuring device 20, and the radio waves containing the adjusting set value based on the measurement result concerned is received from the measuring device 20, whereby the electrical characteristic of the receiver 14 can be adjusted.

In the above embodiments, the radio wave output from the transmitter 13 is set as the RF radio wave, and the radio wave output from the transmitter 23 is set as the LF radio wave. However, the present invention is not limited to this, and the object of the present invention can be attained insofar as radio waves are wirelessly transmitted.

In the above embodiments, the memory 22 for storing the measurement result of the measuring circuit 25 and/or the measurement result of the measuring circuit 15 and the adjusting set value in association with each other is provided to set the adjusting set value. However, the present invention is not limited to these embodiments. However, the adjusting set value can be easily set if the adjusting set value is set by using the memory 22.

What is claimed is:

1. A transceiver comprising:
a transmitter for transmitting a radio wave wirelessly;
a receiver for receiving a radio wave wirelessly from an external device;
a rewritable memory for storing a set value to control an electrical characteristic of at least one of the transmitter and the receiver; and
a controller for controlling the electrical characteristic of the at least one of the transmitter and the receiver based on the set value, and rewriting the set value stored in the memory to a set value received by the receiver when the radio wave containing the set value is received by the receiver.

2. The transceiver according to claim 1, wherein the controller transmits the radio wave from the transmitter when receiving the radio wave containing a transmission request signal indicating a request for transmission of the radio wave through the receiver, whereby the radio wave containing the set value are received from the external device by the receiver.

3. The transceiver according to claim 1, wherein the controller controls a parameter including at least one of a transmission power and a transmission frequency of the transmitter based on the set value.

4. The transceiver according to claim 1, further comprising:
a measuring circuit for measuring the electrical characteristic of the receiver based on the radio wave received by the receiver,
wherein the controller transmits the radio wave containing a measurement result of the measuring circuit from the transmitter, whereby the radio wave containing the set value based on the measuring result is received from the external device by the receiver.

5. The transceiver according to claim 1, wherein the controller controls a parameter including at least one of a reception sensitivity and a reception frequency of the receiver based on the set value.

6. The transceiver according to claim 1, wherein the transmitter transmits an RF radio wave.

7. A transceiver adjusting system in which a transceiver and a measuring device are connected to each other so that wireless communications is performed therebetween, wherein:
the measuring device comprises:
a device-side transmitter for transmitting a radio wave wirelessly;
a device-side receiver for receiving a radio wave wirelessly from the transceiver; and
a device-side controller for setting an adjusting set value to control an electrical characteristic of the transceiver based on the radio wave transmitted from the transceiver, and transmitting the radio wave containing the adjusting set value from the device-side transmitter, and
the transceiver comprises:
a transceiver-side transmitter for transmitting the radio wave wirelessly;
a transceiver-side receiver for receiving the radio wave wirelessly;
a rewritable transceiver-side memory for storing the set value to control the electrical characteristic of the transceiver; and
a transceiver-side controller for controlling the electrical characteristic of the transceiver based on the set value stored in the transceiver-side memory, and rewriting the set value stored in the transceiver-side memory to the adjusting set value when the radio wave containing the adjusting set value is received by the transceiver-side receiver.

8. The transceiver adjusting system according to claim 7, wherein the measuring device further comprises:
an operating unit that is operable by an operator and outputs an operation signal indicating that the operating unit is operated by the operator; and
a measuring circuit for measuring the electrical characteristic of the transceiver-side transmitter based on the radio wave transmitted from the transceiver,
wherein the device-side controller transmits the radio wave containing a transmission request signal indicating a request of transmission of the radio wave from the transceiver and sets the adjusting set value by using the measurement result measured based on the radio wave transmitted from the transceiver, when the operation signal is output, and
wherein the transceiver-side controller transmits the radio wave from the transceiver-side transmitter, when the radio wave containing the transmission request signal is received by the transceiver-side receiver.

9. The transceiver adjusting system according to claim 8, wherein the device-side controller determines based on the measurement result of the measuring circuit whether the electrical characteristic of the transceiver-side transmitter is normal, and sets the adjusting set value and transmits the radio wave containing the adjusting set value from the device-side transmitter, when it is determined that the electrical characteristic is not normal.

10. The transceiver adjusting system according to claim 8, wherein:
the transceiver-side controller controls a transmission power and a transmission frequency of the transceiver-side transmitter as the electrical characteristic;
the device-side measuring circuit measures the transmission power and/or the transmission frequency of the transceiver-side transmitter as the electrical characteristic; and
the device-side controller sets the adjusting set value to control the transmission output and/or the transmission frequency as the adjusting set value.

11. The transceiver adjusting system according to claim 7, wherein:
the transceiver is equipped with a transceiver-side measuring circuit for measuring the electrical characteristic of the transceiver-side receiver based on the radio wave received in the transceiver-side receiver;
the transceiver-side controller transmits the radio wave containing the measurement result of the transceiver-side measuring circuit from the transceiver-side transmitter; and
the device-side controller sets the adjusting set value by using the measurement result measured by the transceiver-side measuring circuit when the adjusting set value is set.

12. The transceiver adjusting system according to claim 11, wherein:
the device-side controller determines based on the measurement result of the transceiver-side measuring circuit whether the electrical characteristic of the transceiver-side receiver is normal; and
the device-side controller sets the adjusting set value and transmits the radio wave containing the adjusting set value from the transmitter when it is determined that the electrical characteristic concerned is not normal.

13. The transceiver adjusting system according to claim 11, wherein:
the transceiver-side controller controls a reception sensitivity and/or a reception frequency of the transceiver-side receiver;
the transceiver-side measuring circuit measures the reception sensitivity and/or the reception frequency of the transceiver-side receiver as the electrical characteristic; and
the device-side controller sets the adjusting set value to control the reception sensitivity and/or the reception frequency.

14. The transceiver adjusting system according to claim 8, wherein:
the measuring device is equipped with a memory for storing the measurement result of the device-side measuring circuit and/or the measurement result of the transceiver-side measuring circuit and the adjusting set value in association with each other, and the device-side controller sets the adjusting set value by using the memory.

15. The transceiver adjusting system according to claim 7, wherein the transceiver-side transmitter transmits an RF radio wave.
